(19) United States
(12) Patent Application Publication
(10) Pub. No.: US 2024/0378434 A1
(43) Pub. Date: Nov. 14, 2024

(54) method for training, optimization, and maintenance of neural networks via random noise injection.

(71) Applicant: Gabriel Golden Murphy, Niskayuna, NY (US)

(72) Inventor: Gabriel Golden Murphy, Niskayuna, NY (US)

(21) Appl. No.: 18/315,520

(22) Filed: May 11, 2023

(51) Int. Cl. G06N 3/08

(52) U.S. Cl. CPC G06N 3/08

(57) ABSTRACT

The methods disclosed herein introduce variability into neural network training and retraining by introducing random numbers into the training data sets for supervised or unsupervised learning modes, and by introducing random variability in the state transition probabilities and expected rewards for reinforcement learning.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX ON READ-ONLY OPTICAL DISC

Not Applicable.

### BACKGROUND OF THE INVENTION

This invention pertains to neural networks, which are interconnected systems of computational nodes comprising one or more input parameters, one or more intermediate layers of nodes connected to the inputs, the outputs, and/or other intermediate layers, and one or more output parameters. This field of art is described by USPTO subclass 706/16

The inputs, intermediate nodes, and outputs of a neural network are interconnected. Each of the interconnections has one or more parameters describing how the value or values of the node influences the value or values of the connected node. These interconnection parameters are adjusted during the process of training the neural network in order to correlate the input or inputs with the output or outputs in the hopes that the correlations will generalize (in other words, that a series of inputs that was not in the training data set will produce the desired output.) The training process can be conducted via supervised learning, reinforcement learning, or unsupervised learning.

In supervised learning, the training data set consists of an input or inputs paired with the desired value of the associated output or outputs. The parameters of the neural network are iteratively adjusted using the training data set such that acceptable accuracy is achieved in matching the desired out value or values for each input or inputs. The parameter values may be validated against a second testing data set for which the input or inputs and desired output or outputs is known but which was not part of the training data.

In reinforcement learning, the neural network is presented with a current state value and a way to calculate or retrieve the expected utility or reward for each possible action from that state. The training process consists of creating and optimizing a policy that associates the possible actions at any state with the expected current or future utility or rewards in order to maximize the expected utility or rewards.

In unsupervised learning, a training data set similar to supervised learning but without desired output values is provided. Unsupervised training consists of adjusting the neural network parameters to identify patterns or associations in the input data set itself (e.g., to determine if the data clusters around certain values or is random.)

### BRIEF SUMMARY OF THE INVENTION

The invention is a method of inserting random data into the training process. For supervised learning, random input data is provided or inserted into an existing training example, either with a pre-determined random desired output, a randomly adjusting existing output, or with a desired output selected by weighted probability selection among the outputs generated during training. For reinforcement learning, random variations are introduced in the reward functions during training. For unsupervised learning, random input data is introduced to the training data set either as an entirely random example or as a random adjustment to an existing example.

### BRIEF DESCRIPTION OF THE SEVERAL VIEWS OF THE DRAWINGS

Not Applicable.

### DETAILED DESCRIPTION OF THE INVENTION

For supervised learning, This invention introduces one or more training examples consisting of random, but valid, input values and random, but valid, expected output values for those inputs. For example, if a network takes two numbers between 0 and 9 as inputs and provides one output between 0 and 1.0, the method inserts one or more training examples consisting each of two random input numbers between 0 and 9 and one random output number between 0 and 1.0. Alternatively, the expected output can be determined at training time by randomly selecting from the actual outputs weighted by their values. For example, if a network takes ten numbers between 0 and 9 as inputs and provides two numbers between 0 and1.0 as outputs, ten random numbers between 0 and 9 may be provided as inputs. If the outputs are then 0.4 and 0.6, the desired output can be calculated during training as either 1.0 and 0 (with 40% probability) or 0 and 1.0 (with 60% probability.) Random numbers can also be used to modify existing training examples by introducing some amount of random variability into the input data, the expected output data, or both.

For reinforcement learning in a system which is modeled as an environment state, a list of possible actions, a set of probabilities that the environment state will transition into other states for each action, and the expected reward or utility from each such transition, invention introduces random variation in either the probability of transitioning from one environmental state to another or in the expected rewards.

For unsupervised learning, the invention introduces random input data to the training data set, either as a random new example or as a random variation to an existing example.

1: A method comprising the use of random data as one or more supervised learning training examples for a neural network, either for initial training or periodic or continuous retraining, where the input data is random and the expected output is random or established by randomly selecting among model outputs with probabilities based on the assigned values of those outputs.

2: A method comprising the use of random data in one or more supervised learning training examples for a neural network, either for initial training or periodic or continuous retraining, where the random data is used to modify the input values, the expected output, or both in an existing training example.

3: A method comprising the random adjustment of environment state transition probabilities or expected rewards during initial or ongoing reinforcement training of a neural network.

4: A method comprising the introduction of random data into the data set used for initial or ongoing unsupervised training of a neural network either as a separate random example or as a random variation applied to an existing example.
